(19) United States
(12) Patent Application Publication
(10) Pub. No.: US 2024/0051287 A1
(43) Pub. Date: Feb. 15, 2024

(54) APPARATUS FOR MANUFACTURING GLASS LAMINATED SUBSTRATE AND METHOD OF MANUFACTURING GLASS LAMINATED SUBSTRATE

(71) Applicant: CORNING INCORPORATED, CORNING, NY (US)

(72) Inventors: Eunho Lee, Hwaseong-si (KR); Woo Jin Lee, Cheonan (KR); Jongsup Yeom, Asan-si (KR)

(21) Appl. No.: 18/267,984

(22) PCT Filed: Dec. 7, 2021
(86) PCT No.: PCT/US2021/062116

§ 371 Date: Jun. 16, 2023

(30) Foreign Application Priority Data
Dec. 21, 2020 (KR) 10-2020-0179919

(51) Int. Cl. B32B 43/00; B32B 38/16; B32B 38/00

(52) U.S. Cl. CPC B32B 43/003; B32B 38/162; B32B 38/164; B32B 38/105

(57) ABSTRACT

An apparatus for manufacturing a glass laminated substrate includes a chamber, a cutting apparatus configured to cut the glass laminated substrate within the chamber, and a surface processing apparatus configured to process a surface of the glass laminated substrate that is cut. The cutting apparatus and the surface processing apparatus of the apparatus for manufacturing a glass laminated substrate can be used to manufacture in-line the glass laminated substrate within the chamber.

### CROSS-REFERENCE TO RELATED APPLICATION

This application is based on and claims priority under 35 U.S.C. § 119 to Korean Patent Application No. 10-2020-0179919, filed on Dec. 21, 2020, in the Korean Intellectual Property Office, the disclosure of which is incorporated by reference herein in its entirety.

### BACKGROUND

### 1. Field

The inventive concept relates to an apparatus for and method of manufacturing a glass laminated substrate.

### 2. Description of Related Art

Glass laminated substrates may be cut for various purposes such as electrical connections, handle manufacturing, ventilations, and the like. For example, glass laminated substrates may be cut using technologies such as a CNC router, water jet, or drilling. Recently, there are active studies on a method of quickly cutting a large number of glass laminated substrates.

### SUMMARY

The inventive concept provides an apparatus for and method of manufacturing a glass laminated substrate, by which a large number of glass laminated substrates may be quickly manufactured.

Additional aspects will be set forth in part in the description which follows and, in part, will be apparent from the description, or may be learned by practice of the presented embodiments of the disclosure.

According to an aspect of the inventive concept, there is provided an apparatus for manufacturing a glass laminated substrate, which includes a chamber, a cutting apparatus for cutting the glass laminated substrate, the cutting apparatus being arranged in the chamber and including: a first cutting conveyor belt configured to transfer the glass laminated substrate in a first direction; a second cutting conveyor belt arranged apart from the first cutting conveyor belt in the first direction and configured to transfer the glass laminated substrate in the first direction; and a waterjet cutting apparatus configured to cut the glass laminated substrate by spraying a cutting liquid toward the glass laminated substrate located in a spacing between the first cutting conveyor belt and the second cutting conveyor belt, and a surface processing apparatus arranged beside the cutting apparatus in the chamber for processing a surface of the glass laminated substrate, the surface processing apparatus including: a surface processing conveyor belt arranged apart from the second cutting conveyor belt in the first direction and configured to transfer the glass laminated substrate in the first direction; a beveling apparatus arranged above the surface processing conveyor belt and configured to chamfer a part of the glass laminated substrate that is cut; a cleaning apparatus arranged above the surface processing belt and configured to clean a surface of the glass laminated substrate; and a drying apparatus arranged above the surface processing conveyor belt and configured to dry the surface of the glass laminated substrate.

In an embodiment, the cutting apparatus of the glass laminated substrate may further include a waterjet tank arranged between the first cutting conveyor belt and the second cutting conveyor belt and configured to store the cutting liquid discharged from the waterjet cutting apparatus.

In an embodiment, the cutting apparatus of the glass laminated substrate may further include a third cutting conveyor belt arranged apart from the second cutting conveyor belt in the first direction and configured to transfer the glass laminated substrate in the first direction, and the waterjet cutting apparatus may be further configured to move in a direction parallel to the first direction and to spray the cutting liquid toward at least one of the glass laminated substrate arranged between the first cutting conveyor belt and the second cutting conveyor belt or the glass laminated substrate arranged between the second cutting conveyor belt and the third cutting conveyor belt.

In an embodiment, the waterjet tank may be further configured to move in a direction parallel to the first direction in the chamber based on a movement of the waterjet cutting apparatus in the direction parallel to the first direction.

In an embodiment, the beveling apparatus may include a base portion, a glass beveling portion arranged above the base portion and configured to grind a glass layer of the glass laminated substrate through rotation, and a substrate beveling portion arranged below the base portion and configured to grind a substrate under the glass layer of the glass laminated substrate through rotation.

In an embodiment, the cleaning apparatus may include a cleaning liquid sprayer configured to spray a cleaning liquid onto the surface of the glass laminated substrate.

In an embodiment, the drying apparatus may include at least one of an air knife or an air curtain, which is configured to spray air onto the surface of the glass laminated substrate.

In an embodiment, at least one of the first cutting conveyor belt, the second cutting conveyor belt, or the surface processing conveyor belt may include a plurality of rollers arranged apart from one another in the first direction, a transfer belt surrounding the plurality of rollers and having a plurality of vacuum holes in a surface thereof, and a vacuum pump configured to supply a low pressure to the plurality of vacuum holes of the transfer belt.

In an embodiment, at least one of the first cutting conveyor belt, the second cutting conveyor belt, or the surface processing conveyor belt may include a plurality of rollers arranged apart from one another in the first direction, and a transfer belt surrounding the plurality of rollers and including a rubber magnet.

In an embodiment, at least one of the first cutting conveyor belt, the second cutting conveyor belt, or the surface processing conveyor belt may include a plurality of rollers arranged apart from one another in the first direction and each including a paramagnetic material that is magnetized in a direction parallel to a direction of a magnetic field, a transfer belt surrounding the plurality of rollers, and a magnetic field generation apparatus configured to generate a magnetic field to magnetize the plurality of rollers.

In an embodiment, at least one of the first cutting conveyor belt, the second cutting conveyor belt, or the surface processing conveyor belt may further include a magnetic field generation apparatus configured to generate a magnetic field to magnetize the plurality of rollers, and the plurality of rollers each may include a paramagnetic material that is magnetized in a direction parallel to a direction of the magnetic field.

According to another aspect of the inventive concept, there is provided a method of manufacturing a glass laminated substrate, which includes cutting the glass laminated substrate, chamfering a part of the glass laminated substrate, cleaning the glass laminated substrate, and drying the glass laminated substrate, wherein the cutting, chamfering, cleaning, and drying of the glass laminated substrate are performed within a single chamber.

In an embodiment, the cutting of the glass laminated substrate may include transferring the glass laminated substrate in a first direction via a first cutting conveyor belt, cutting, by using a waterjet cutting apparatus, a part of the glass laminated substrate that passed the first cutting conveyor belt, and transferring, via a second cutting conveyor belt that is apart from the first cutting conveyor belt in the first direction, the glass laminated substrate that is cut.

In an embodiment, the cutting, by using the waterjet cutting apparatus, of a part of the glass laminated substrate that passed the first cutting conveyor belt, may include controlling a movement of a waterjet tank that stores a cutting liquid sprayed by the waterjet cutting apparatus, based on a movement of the waterjet cutting apparatus in a direction parallel to the first direction.

In an embodiment, the transferring of the glass laminated substrate in the first direction via the first cutting conveyor belt may include any one of fixing the glass laminated substrate on the first cutting conveyor belt through a vacuum and fixing the glass laminated substrate on the first cutting conveyor belt through electrostatic attraction, and the transferring of the glass laminated substrate in the first direction via the second cutting conveyor belt may include any one of fixing the glass laminated substrate on the second cutting conveyor belt through a vacuum and fixing the glass laminated substrate on the second cutting conveyor belt through electrostatic attraction.

In an embodiment, the chamfering of a part of the glass laminated substrate may include grinding a glass layer of the glass laminated substrate and a substrate disposed under the glass layer through rotation of a beveling apparatus while the glass laminated substrate is moving in the first direction.

In an embodiment, the cleaning of the glass laminated substrate may include spraying a cleaning liquid onto a surface of the glass laminated substrate while the glass laminated substrate is moving in the first direction.

In an embodiment, the drying of the glass laminated substrate may include spraying air onto a surface of the glass laminated substrate while the glass laminated substrate is moving in the first direction.

In an embodiment, the method may further include inspecting a surface of the glass laminated substrate, and packing the glass laminated substrate, wherein the cutting, chamfering, cleaning, drying, inspecting, and packing of the glass laminated substrate are performed within a single chamber.

The apparatus for manufacturing a glass laminated substrate according to an embodiment may include a chamber, a cutting apparatus arranged within a chamber and configured to cut the glass laminated substrate, and a surface processing apparatus arranged within the chamber and configured to process a surface of the glass laminated substrate cut by the cutting apparatus.

Accordingly, according to an apparatus for manufacturing a glass laminated substrate and a method of manufacturing a glass laminated substrate including the apparatus for manufacturing a glass laminated substrate, a large amount of glass laminated substrates may be quickly manufactured within a single chamber.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows a schematic view of a glass laminated substrate and a cross-section thereof;

FIG. 2 is a view of an apparatus for manufacturing a glass laminated substrate according to a comparative example;

FIG. 3 is a cross-sectional view of an apparatus for manufacturing a glass laminated substrate according to an embodiment;

FIGS. 4 to 6 are cross-sectional views of an apparatus for cutting a glass laminated substrate according to an embodiment;

FIG. 7 is a cross-sectional view of an apparatus for edging a glass laminated substrate according to an embodiment;

FIG. 8 is a cross-sectional view of an apparatus for cleaning a glass laminated substrate according to an embodiment;

FIG. 9 is a cross-sectional view of an apparatus for drying a glass laminated substrate according to an embodiment;

FIGS. 10 and 12 are cross-sectional views of a conveyor belt according to an embodiment;

FIG. 13 is a flowchart of a method of manufacturing a glass laminated substrate according to an embodiment;

FIG. 14 is a flowchart of an operation of cutting a glass laminated substrate according to an embodiment; and

FIG. 15 is a flowchart of a method of manufacturing a glass laminated substrate according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The disclosure will now be described more fully with reference to the accompanying drawings, in which embodiments of the disclosure are shown. The disclosure may, however, be embodied in many different forms and should not be construed as being limited to the embodiments set forth herein;
rather, these embodiments are provided so that this disclosure will be thorough and complete, and will fully convey the concept of the disclosure to those of ordinary skill in the art. Like reference numerals in the drawings denote like elements. Furthermore, various elements and areas are schematically illustrated in the drawings. Accordingly, the concept of the disclosure is not limited by relatively sizes or intervals illustrated in the accompanying drawings.

While such terms as “first,” “second,” etc., may be used to describe various components, such components must not be limited to the above terms. The above terms are used only to distinguish one component from another. For example, without departing from the right scope of the disclosure, a first constituent element may be referred to as a second constituent element, and vice versa.

Terms used in the specification are used for explaining a specific embodiment, not for limiting the disclosure. Thus, an expression used in a singular form in the specification also includes the expression in its plural form unless clearly specified otherwise in context. Also, terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

Unless defined otherwise, all terms used herein including technical or scientific terms have the same meanings as those generally understood by those of ordinary skill in the art to which the disclosure may pertain. The terms as those defined in generally used dictionaries are construed to have meanings matching that in the context of related technology and, unless clearly defined otherwise, are not construed to be ideally or excessively formal.

When a certain embodiment may be implemented differently, a specific process order may be performed differently from the described order. For example, two consecutively described processes may be performed substantially at the same time or performed in an order opposite to the described order.

In the accompanying drawings, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing. As used herein, the term “and/or” includes any and all combinations of one or more of the associated listed items.

Furthermore, the term “substrate” used herein may mean a substrate by itself, or a stack structure including a substrate and a certain layer or film formed on a surface thereof. Furthermore, the term “surface of a substrate” used herein may mean an exposed surface of a substrate by itself, or an external surface such as a certain layer or film formed on the substrate.

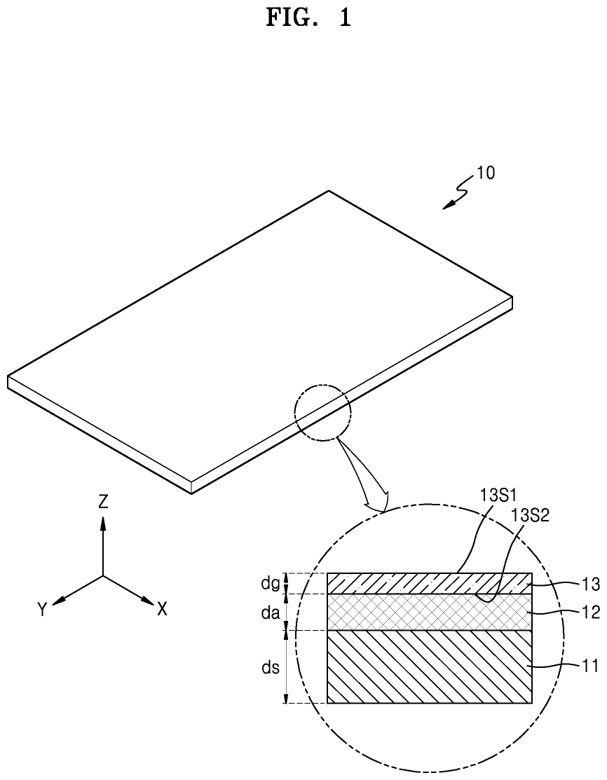

FIG. 1 is a schematic view of a glass laminated substrate 10, showing a cross-section thereof

Referring to FIG. 1, the glass laminated substrate 10 may include a substrate 11, a glass layer 13 laminated on the substrate 11, and an adhesive layer 12 for laminating the glass layer 13 on the substrate 11. For example, the glass laminated substrate 10 may have a structure in which the substrate 11, the adhesive layer 12, and the glass layer 13 are sequentially stacked.

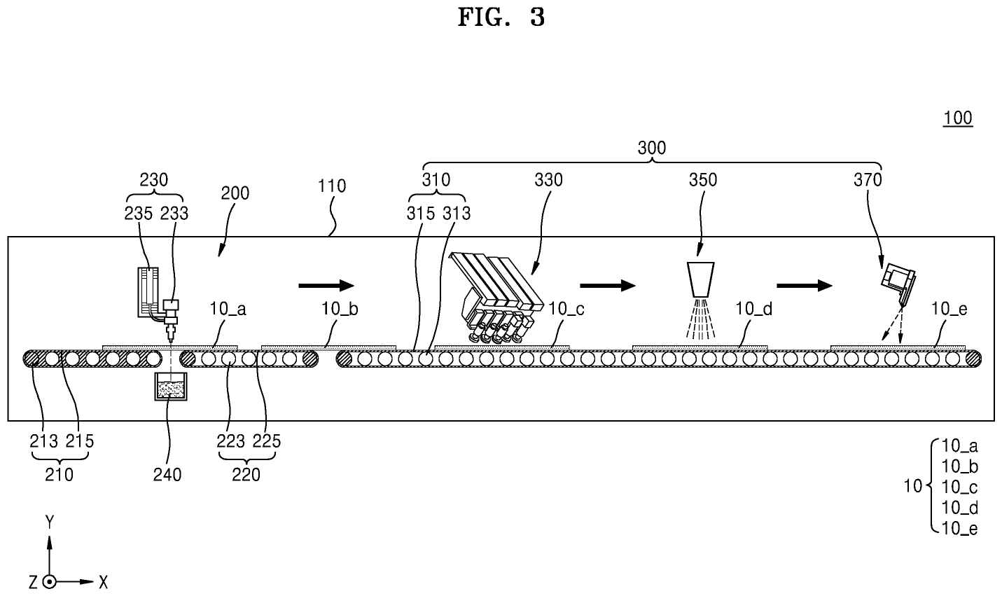

In an embodiment, the glass laminated substrate 10 may be manufactured by an apparatus 100 for manufacturing a glass laminated substrate (see FIG. 3) that is described below. For example, the glass laminated substrate 10 may be cut by the apparatus 100 for manufacturing a glass laminated substrate. Furthermore, a cutting surface of the glass laminated substrate 10 may be ground by the apparatus 100 for manufacturing a glass laminated substrate. Furthermore, the glass laminated substrate 10 may be cleaned and dried by the apparatus 100 for manufacturing a glass laminated substrate.

The technical concepts related to cutting, grinding, cleaning, drying, and the like of the glass laminated substrate 10 according to an embodiment are described below in detail with reference to FIGS. 3 to 15.

The substrate 11 of the glass laminated substrate 10 may include metal, wood, an inorganic material, an organic material, or a combination thereof, but the disclosure is not limited thereto. For example, the substrate 11 may include a high pressure laminate (HPL), paint-coated metal (PCM), a medium density fiberboard (MDF), vinyl-coated metal (VCM), or steel, but the disclosure is not limited thereto. In an embodiment, a thickness ds of the substrate 11 may be about 500 micrometers or more.

The glass layer 13 of the glass laminated substrate 10 may include borosilicate, aluminosilicate, boro aluminosilicate, alkali borosilicate, alkali aluminosilicate, alkali boro aluminosilicate, or soda lime, but the disclosure is not limited thereto.

In an embodiment, among the surfaces of the glass layer 13, a surface forming a top layer of the glass laminated substrate 10 may be defined as a first surface 13S1. For example, the first surface 13S1 of the glass layer 13 may be an upper surface of the glass layer 13 that is exposed to the outside. Furthermore, of the surfaces of the glass layer 13, a surface contacting the adhesive layer 12 may be defined as a second surface 13S2. For example, the second surface 13S2 of the glass layer 13 may be opposite to the first surface 13S1 and may be a lower surface of the glass layer 13 that is not exposed to the outside.

In an embodiment, a thickness dg of the glass layer 13 may be about 25 micrometers or more. For example, the thickness dg of the glass layer 13 may be about 25 micrometers to about 700 micrometers. In detail, the thickness dg of the glass layer 13 may be about 100 micrometers to about 150 micrometers.

The adhesive layer 12 of the glass laminated substrate 10 may be a layer that fixedly combined the substrate 11 and the glass layer 13. For example, the adhesive layer 12 may include a pressure sensitive adhesive (PSA), optically clear resin (OCR), or an optically clear adhesive (OCA), but the disclosure is not limited thereto.

In an embodiment, a thickness da of the adhesive layer 12 may be about 50 micrometers to about 300 micrometers. In detail, the thickness da of the adhesive layer 12 may be about 75 micrometers to about 125 micrometers.

In an embodiment, the glass laminated substrate 10 may further include an image film layer (not shown) between the substrate 11 and the adhesive layer 12. The image film layer may be a film in which an image layer is printed on a polymer base.

In an embodiment, the polymer base may include a polypropylene (PP) film, a polyethylene terephthalate (PET) film, a polystyrene (PS) film, an acrylonitrile butadiene styrene (ABS) resin film, a high density polyethylene (HDPE) film, a low density polyethylene (LDPE) film, a polyvinyl chloride (PVC) film, a polyethylene naphthalate film, a polybutylene terephthalate film, a polycarbonate (PC), or a stacked film thereof.

In an embodiment, an image layer may be a print layer on which a content in characters, images, symbols, and the like is printed. The image layer may be formed by, for example, inkjet printing or laser printing. The image layer may include a pigment component of ink for inkjet printers, or a pigment component of toner for laser printers.

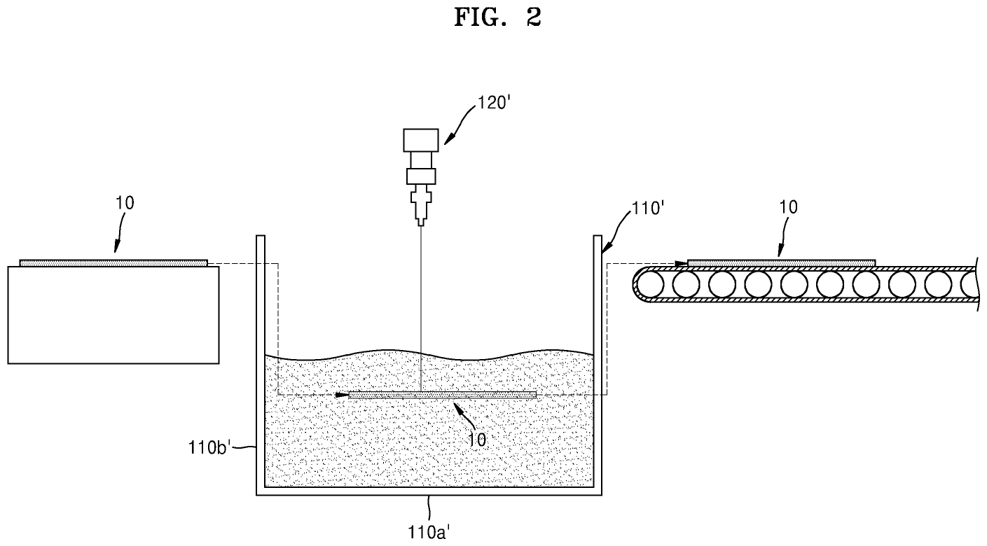

FIG. 2 is a view of an apparatus 100′ for manufacturing the glass laminated substrate 10 according to a comparative example.

Referring to FIG. 2, the apparatus 100′ for manufacturing the glass laminated substrate 10 according to a comparative example may include an open tank 110′ and a waterjet device 120′.

The open tank 110′ may have a lower surface 110a′ and a side surface 110b′ extending in a direction perpendicular to the lower surface 110a′. The open tank 110′ may include an opening in an upper potion thereof. For example, the open tank 110′ may have a tub shape having an opening that provides a movement path of the glass laminated substrate 10 in the upper portion thereof.

The inner space of the open tank 110′ may be a space that is defined by the lower surface 110a′ and the side surface 110b′. The glass laminated substrate 10 may be arranged in the inner space of the open tank 110′ for cutting.

The waterjet device 120′ may be configured to spray a cutting liquid onto a surface of the surface of the glass laminated substrate 10. The waterjet device 120′ may spray the cutting liquid, at high pressure, onto the surface of the glass laminated substrate 10 arranged in the inner space of the open tank 110′. The glass laminated substrate 10 may be cut by the cutting liquid at high pressure provided by the waterjet device 120′. Furthermore, the liquid sprayed by the waterjet device 120′ may be accommodated in the inner space of the open tank 110′.

A method of manufacturing the glass laminated substrate 10 by using the apparatus 100′ for manufacturing the glass laminated substrate 10 according to a comparative example may include inputting the glass laminated substrate 10 into the inner space of the open tank 110′, cutting the glass laminated substrate 10 arranged in the open tank 110′ by using the waterjet device 120′, carrying out the glass laminated substrate 10, which is cut, from the inner space of the open tank 110′, processing the cutting surface of the glass laminated substrate 10 that is cut, and the like.

The operations of inputting the glass laminated substrate 10 into the inner space of the open tank 110′ and the carrying out the glass laminated substrate 10, which is cut, from the inner space of the open tank 110′, according to a comparative example, may be carried out through a transfer member such as a robot arm.

As the method of manufacturing the glass laminated substrate 10 according to a comparative example includes the operations of inputting the glass laminated substrate 10 into the inner space of the open tank 110′ and carrying out the glass laminated substrate 10, which is cut, from the inner space of the open tank 110′, and the size of the inner space provided by the open tank 110′ is limited, actually, it may be difficult to quickly cut a large amount of the glass laminated substrates 10.

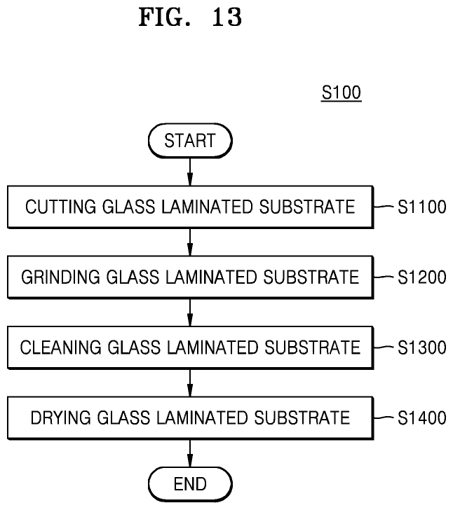

In the following description, to solve the above-described problems, the apparatus for manufacturing the glass laminated substrate 10 according to an embodiment (100 of FIG. 3) and the method of manufacturing the glass laminated substrate 10 (S100 of FIG. 13) are provided.

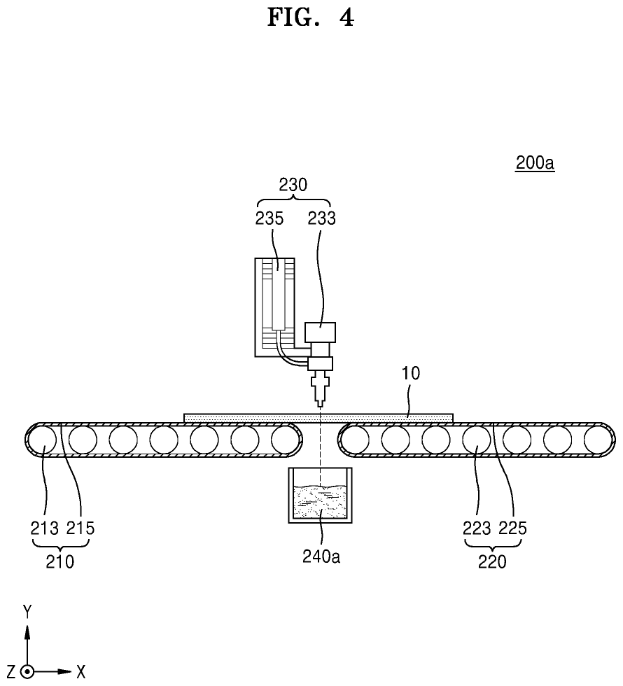

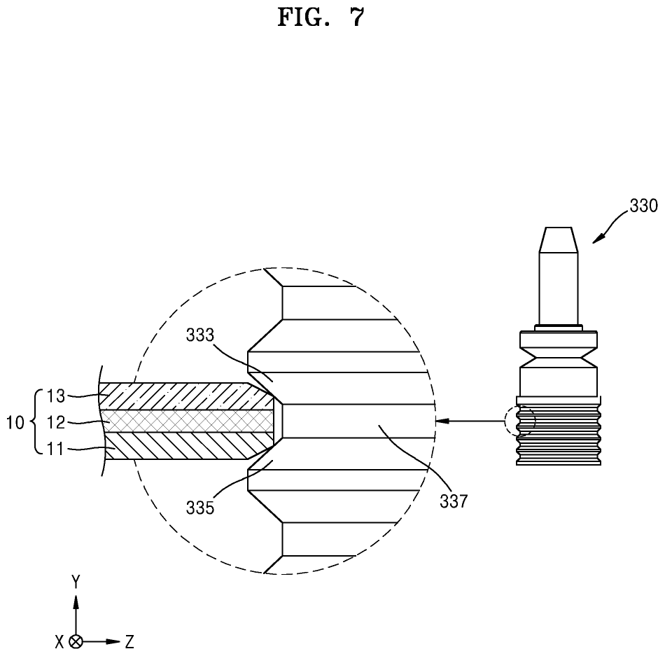

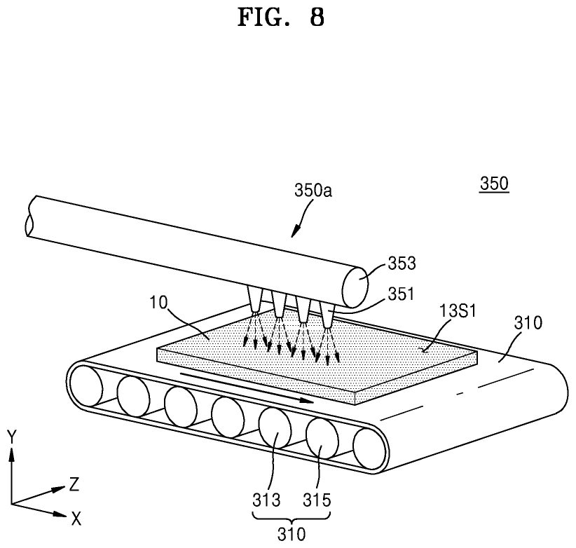

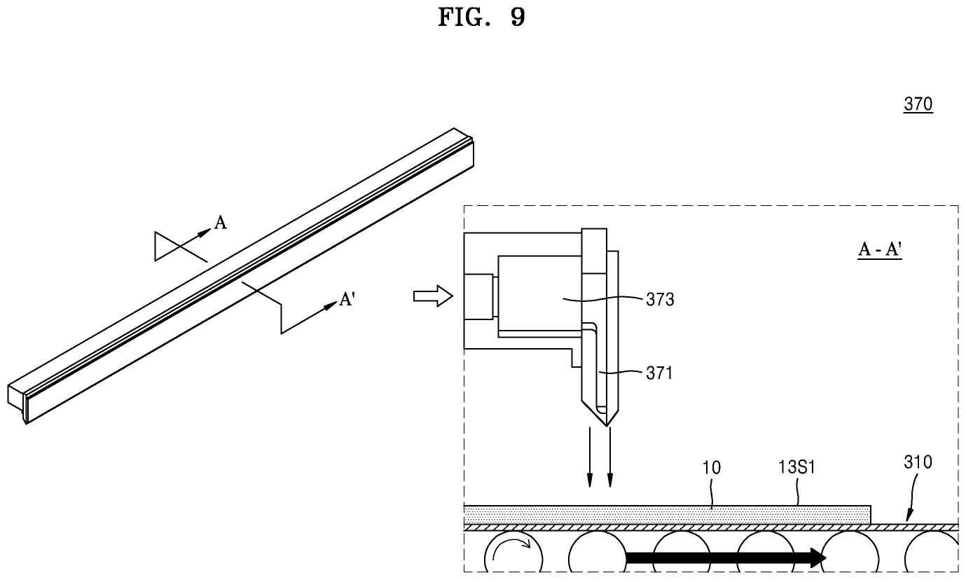

FIG. 3 is a cross-sectional view of an apparatus 100 for manufacturing the glass laminated substrate 100 according to an embodiment. FIGS. 4 to 6 are cross-sectional views of apparatuses 200a, 200b, and 200c for cutting the glass laminated substrate 10 according to an embodiment. FIG. 7 is a cross-sectional view of an apparatus 330 for edging the glass laminated substrate 10 according to an embodiment. FIG. 8 is a cross-sectional view of an apparatus 350 for cleaning the glass laminated substrate 10 according to an embodiment. Furthermore, FIG. 9 is a cross-sectional view of a drying apparatus 370 for drying the glass laminated substrate 10 according to an embodiment.

Referring to FIGS. 3 to 9 together, the apparatus 100 for manufacturing the glass laminated substrate 10 according to an embodiment may include a chamber 110, a cutting apparatus 200 for cutting a glass laminated substrate, and a surface processing apparatus 300 for processing a surface of a glass laminated substrate.

The chamber 110 may provide a process space in which a plurality of processes for manufacturing the glass laminated substrate 10. In an embodiment, the chamber 110 may provide a process space in which processes such as cutting, grinding, cleaning, drying, and the like of the glass laminated substrate 10 is performed.

In an embodiment, the process space of the chamber 110 may be a space in which the cutting apparatus 200 for cutting a glass laminated substrate, the surface processing apparatus 300 for processing a surface of the glass laminated substrate 10, and the like are arranged.

In an embodiment, a plurality of processes for manufacturing the glass laminated substrate 10 may be performed in-line within the chamber 110 that is one. For example, the operation of transferring the glass laminated substrate 10 to the next stage by using a transfer apparatus such as a robot arm may not be provided between a plurality of processes of the glass laminated substrate 10, such as, a cutting process, a grinding process, a cleaning process, a drying process, and the like. Accordingly, the cutting process, the grinding process, the cleaning process, and the drying processes of the glass laminated substrate 10 may be sequentially and quickly performed within the chamber 110 that is one.

Furthermore, a plurality of glass laminated substrates 10 may be simultaneously manufactured within the chamber 110. For example, first to fifth glass laminated substrates 10_a, 10_b, 10_c, 10_d, and 10_e may be simultaneously manufactured within the chamber 110.

In an embodiment, the first glass laminated substrate 10_a may be a glass laminated substrate on which a cutting process is performed by the cutting apparatus 200. Furthermore, the second glass laminated substrate 10_b may be a glass laminated substrate that is transferred from the cutting apparatus 200 to the surface processing apparatus 300 for the grinding process after the cutting process is completed. Furthermore, the third glass laminated substrate 10_c may be a glass laminated substrate on which the grinding process is performed after the cutting process is completed. Furthermore, the fourth glass laminated substrate 10_d may be a glass laminated substrate on which the cleaning process is performed after the cutting process and the grinding process are completed. Furthermore, the fifth glass laminated substrate 10_e may be a glass laminated substrate on which the drying process is performed after the cutting process, the grinding process, and the cleaning process are completed.

In an embodiment, while the first to fifth glass laminated substrates 10_a, 10_b, 10_c, 10_d, and 10_e are transferred in a first direction, that is, an X direction, that is a process progress direction, the cutting process, the grinding process, the cleaning process, and the drying process of the glass laminated substrate 10 may be simultaneously performed.

In FIG. 3, although the number of the glass laminated substrates 10 that are manufactured within the chamber 110 is illustrated to be five, the number of the glass laminated substrates 10 that are manufactured within the chamber 110 is not limited to the above description.

Referring to FIGS. 3 to 5 together, the cutting apparatus 200 for cutting a glass laminated substrate may be configured to cut the glass laminated substrate 10. In an embodiment, the cutting apparatus 200 for cutting a glass laminated substrate may be configured to cut the glass laminated substrate 10 such that the cutting surface of the glass laminated substrate 10 has a flat surface or a curved surface.

In an embodiment, the cutting apparatus 200 for cutting a glass laminated substrate may include a first cutting conveyor belt 210, a second cutting conveyor belt 220, a waterjet cutting apparatus 230, and a waterjet tank 240.

The first cutting conveyor belt 210 of the cutting apparatus 200 for cutting a glass laminated substrate may be a conveyor belt for transferring the glass laminated substrate 10 in the first direction, that is, the X direction, to perform the cutting process of the glass laminated substrate 10. For example, the first direction, that is, the X direction, may be substantially the same direction as the process progress direction of the glass laminated substrate 10, that is, a direction in which the glass laminated substrate 10 is transferred.

In an embodiment, the first cutting conveyor belt 210 may include a plurality of first cutting rollers 213 and a first cutting transfer belt 215 encompassing the first cutting rollers 213.

In an embodiment, as the first cutting rollers 213 rotate clockwise, the first cutting transfer belt 215 encompassing the first cutting rollers 213 may also rotate clockwise. Accordingly, the glass laminated substrate 10 placed on the first cutting transfer belt 215 may be transferred in the first direction, that is, the X direction, which is the process progress direction.

The second cutting conveyor belt 220 of the cutting apparatus 200 for cutting a glass laminated substrate may be a conveyor belt for transferring the glass laminated substrate 10 that is cut by the waterjet cutting apparatus 230, in the first direction, that is, the X direction. Furthermore, the second cutting conveyor belt 220 may be a conveyor belt configured to receive the glass laminated substrate 10 from the first cutting conveyor belt 210 and transfer the glass laminated substrate 10 in the first direction, that is, the X direction.

In an embodiment, the second cutting conveyor belt 220 may be arranged to be spaced apart from the first cutting conveyor belt 210 in the first direction, that is, the X direction. A separation space between the first cutting conveyor belt 210 and the second cutting conveyor belt 220 may be a cutting space in which the cutting of the glass laminated substrate 10 is performed by the waterjet cutting apparatus 230.

In an embodiment, the second cutting conveyor belt 220 may include a plurality of second cutting rollers 223 and a second cutting transfer belt 225 encompassing the second cutting rollers 223.

In an embodiment, as the second cutting rollers 223 rotate clockwise, the second cutting transfer belt 225 encompassing the second cutting rollers 223 may also rotate clockwise. Accordingly, the glass laminated substrate 10 placed on the second cutting transfer belt 225 may be transferred in the first direction, that is, the X direction, which is the process progress direction.

The waterjet cutting apparatus 230 of the cutting apparatus 200 for cutting a glass laminated substrate may be provided above the first cutting conveyor belt 210 and the second cutting conveyor belt 220 and configured to cut the glass laminated substrate 10 by spraying the cutting liquid onto the glass laminated substrate 10 arranged in the separation space between the first cutting conveyor belt 210 and the second cutting conveyor belt 220.

In an embodiment, the cutting liquid sprayed by the waterjet cutting apparatus 230 may be water. However, the disclosure is not limited thereto, and the cutting liquid may be a mixed water of water and abrasives.

In an embodiment, the waterjet cutting apparatus 230 may be configured to cut the glass laminated substrate 10 by spraying the cutting liquid onto the glass laminated substrate 10 arranged in the separation space between the first cutting conveyor belt 210 and the second cutting conveyor belt 220, in a direction, that is, a Y direction, perpendicular to a direction in which the first surface 13S1 of the glass laminated substrate 10 extends. However, the disclosure is not limited thereto, and the waterjet cutting apparatus 230 may be configured to cut the glass laminated substrate 10 by spraying the cutting liquid in a state of being inclined at a certain angle with respect to an axis extending in the direction, that is, the Y direction, perpendicular to the direction in which the first surface 13S1 of the glass laminated substrate 10 extends.

In an embodiment, the waterjet cutting apparatus 230 may be configured to cut the glass laminated substrate 10 by spraying the cutting liquid in a state of being inclined at about 3° to about 10° with respect to a first axis extending in the direction, that is, the Y direction, perpendicular to the direction in which the first surface 13S1 of the glass laminated substrate 10 extends. For example, the waterjet cutting apparatus 230 may be configured to cut the glass laminated substrate 10 by spraying the cutting liquid in a state of being inclined at about 7° to about 8° with respect to the first axis.

In an embodiment, a spray pressure of the cutting liquid of the waterjet cutting apparatus 230 may be flexibly adjusted. For example, a first spray pressure of the waterjet cutting apparatus 230 for cutting the glass layer 13 of the glass laminated substrate 10 may be different from a second spray pressure of the waterjet cutting apparatus 230 for cutting the substrate 11 of the glass laminated substrate 10. For example, the first spray pressure may be less than the second spray pressure.

For example, the first spray pressure of the waterjet cutting apparatus 230 for cutting the glass layer 13 of the glass laminated substrate 10 may be about 25,000 psi or less. Furthermore, the second spray pressure of the waterjet cutting apparatus 230 for cutting the substrate 11 of the glass laminated substrate 10 may be about 80,000 psi or less. For example, the second spray pressure may be about 25,000 psi to about 80,000 psi.

In an embodiment, the waterjet cutting apparatus 230 may include a spray nozzle 233 configured to spray the cutting liquid, a pump 235 configured to apply a pressure to the cutting liquid, a storage tank (not shown) for storing the cutting liquid, and the like.

In an embodiment, the cutting liquid moved from the storage tank to the spray nozzle 233 may be provided at high speed onto the glass laminated substrate 10 according to a high pressure provided by the pump 235.

In an embodiment, the waterjet cutting apparatus 230 may spray the cutting liquid through the spray nozzle 233 in a state of being spaced apart from the glass laminated substrate 10 in a perpendicular direction by about 10 millimeters to about 20 millimeters. However, the disclosure is not limited thereto, and a separation distance in the perpendicular direction of the waterjet cutting apparatus 230 and the glass laminated substrate 10 may be flexibly adjusted.

In an embodiment, while the glass laminated substrate 10 is transferred by the first cutting conveyor belt 210 and the second cutting conveyor belt 220 in the first direction, that is, the X direction, the waterjet cutting apparatus 230 may cut the glass laminated substrate 10 by spraying the cutting liquid onto the first surface 1351 of the glass laminated substrate 10.

In an embodiment, the waterjet cutting apparatus 230 may be configured to move in at least one of a direction parallel to the second direction, that is, the Y direction, perpendicular to the first direction, that is, the X direction, which is the process progress direction, and a direction parallel to a third direction, that is, a Z direction.

In an embodiment, the waterjet cutting apparatus 230 may move in the direction parallel to the second direction, that is, the Y direction, to control the speed of the cutting liquid that arrives at the first surface 13S1 of the glass laminated substrate 10. In other words, the waterjet cutting apparatus 230 may move in the direction parallel to the second direction, that is, the Y direction, to adjust the cutting intensity of the glass laminated substrate 10.

Furthermore, in an embodiment, the waterjet cutting apparatus 230 may move in a direction parallel to the third direction, that is, the Z direction, to control the shape of the cutting surface of the glass laminated substrate 10.

For example, when the waterjet cutting apparatus 230 performs the cutting of the glass laminated substrate 10 that moves in the first direction, that is, the X direction, while the waterjet cutting apparatus 230 does not move in the third direction, that is, the Z direction, the cutting surface of the glass laminated substrate 10 may have a flat surface.

Furthermore, when the waterjet cutting apparatus 230 performs the cutting of the glass laminated substrate 10 that moves in the first direction, that is, the X direction, while the waterjet cutting apparatus 230 moves in the third direction, that is, the Z direction, the cutting surface of the glass laminated substrate 10 may have a curved surface.

The waterjet tank 240 of the cutting apparatus 200 for cutting a glass laminated substrate may be a tank that is arranged under the first cutting conveyor belt 210 and the second cutting conveyor belt 220, and stores the cutting liquid sprayed by the waterjet cutting apparatus 230 between the first cutting conveyor belt 210 and the second cutting conveyor belt 220.

In an embodiment, as the waterjet tank 240 may store the cutting liquid under the first cutting conveyor belt 210 and the second cutting conveyor belt 220, a physical damage by the cutting liquid to the chamber and components in the chamber 110 may be prevented.

In the following description, first to third apparatuses 200a, 200b, and 200c for cutting a glass laminated substrate according to embodiments are described with reference to FIGS. 3 to 6.

Referring to FIGS. 3 and 4 together, the first apparatus 200a for cutting a glass laminated substrate may include the first cutting conveyor belt 210, the second cutting conveyor belt 220, a waterjet cutting apparatus 230a, and a waterjet tank 240a.

In an embodiment, the first apparatus 200a for cutting a glass laminated substrate may include two cutting conveyor belts. In other words, the first apparatus 200a for cutting a glass laminated substrate may include the first cutting conveyor belt 210 that is one and the second cutting conveyor belt 220 that is one.

Furthermore, the waterjet cutting apparatus 230a may be arranged between the first cutting conveyor belt 210 and the second cutting conveyor belt 220, and may spray the cutting liquid onto the glass laminated substrate 10 arranged in the separation space between the first cutting conveyor belt 210 and the second cutting conveyor belt 220.

In an embodiment, the waterjet cutting apparatus 230a may be configured to move in at least one of the direction parallel to the second direction, that is, the Y direction and the direction parallel to the third direction, that is, the Z direction, without moving in the first direction, that is, the X direction.

In an embodiment, the waterjet tank 240a may be arranged under the chamber 110 and between the first cutting conveyor belt 210 and the second cutting conveyor belt 220. Furthermore, the waterjet tank 240a may be on a lower surface of the chamber 110 to overlap the waterjet cutting apparatus 230a in the third direction, that is, the Z direction.

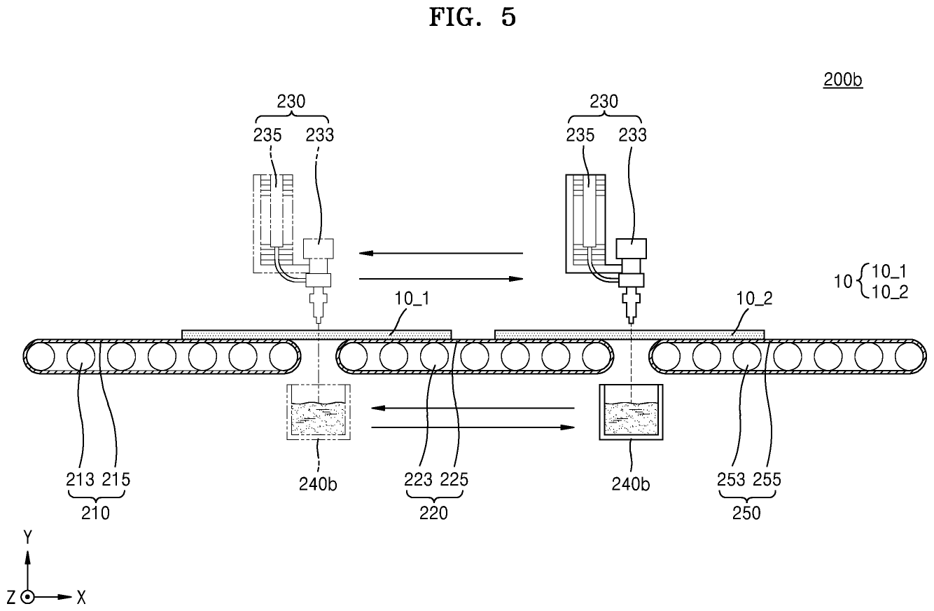

Referring to FIGS. 3 and 5 together, the second apparatus 200b for cutting a glass laminated substrate may include the first cutting conveyor belt 210, the second cutting conveyor belt 220, a third cutting conveyor belt 250, a waterjet cutting apparatus 230b, a waterjet tank 240b, and the like.

In an embodiment, the second apparatus 200b for cutting a glass laminated substrate may include three or more cutting conveyor belts. Although FIG. 5 illustrates that the second apparatus 200b for cutting a glass laminated substrate includes three cutting conveyor belts, the number of the cutting conveyor belts included in the second apparatus 200b for cutting a glass laminated substrate is not limited to the above description.

In an embodiment, the second cutting conveyor belt 220 may be arranged spaced apart from the first cutting conveyor belt 210 in the first direction, that is, the X direction. Furthermore, the separation space between the first cutting conveyor belt 210 and the second cutting conveyor belt 220 may be a first cutting space in which the cutting of the glass laminated substrate 10 is performed by the waterjet cutting apparatus 230b first cutting space.

Furthermore, the third cutting conveyor belt 250 may be arranged spaced apart from the second cutting conveyor belt 220 in the first direction, that is, the X direction. Furthermore, a separation space between the second cutting conveyor belt 220 and the third cutting conveyor belt 250 may be a second cutting space in which the cutting of the glass laminated substrate 10 is performed by the waterjet cutting apparatus 230b.

In an embodiment, the third cutting conveyor belt 250 may include a plurality of third cutting rollers 253 and a third cutting transfer belt 255 encompassing the third cutting rollers 253.

In an embodiment, the waterjet cutting apparatus 230b may be configured to move in at least one of a direction parallel to the first direction, that is, the X direction, the direction parallel to the second direction, that is, the Y direction, and the direction parallel to the third direction, that is, the Z direction.

In an embodiment, the waterjet cutting apparatus 230b may primarily cut a glass laminated substrate 10_1 arranged between the first cutting conveyor belt 210 and the second cutting conveyor belt 220. Then, the waterjet cutting apparatus 230b may move in the first direction, that is, the X direction, and secondarily cut a glass laminated substrate 10_2 arranged between the second cutting conveyor belt 220 and the third cutting conveyor belt 250.

However, the disclosure is not limited thereto, and the waterjet cutting apparatus 230b may primarily cut the glass laminated substrate 10_2 arranged between the second cutting conveyor belt 220 and the third cutting conveyor belt 250 and then move in a direction opposite to the first direction, that is, the X direction, and secondarily cut the glass laminated substrate 10_1 arranged between the first cutting conveyor belt 210 and the second cutting conveyor belt 220.

In an embodiment, the waterjet tank 240b may be configured to move on the lower surface of the chamber 110 in the direction parallel to the first direction, that is, the X direction. Furthermore, the waterjet tank 240b may move in the direction parallel to the first direction, that is, the X direction, to be arranged between the first cutting conveyor belt 210 and the second cutting conveyor belt 220 or between the second cutting conveyor belt 220 and the third cutting conveyor belt 250.

In an embodiment, the waterjet tank 240b may be configured to move based on the movement of the waterjet cutting apparatus 230b in the direction parallel to the first direction, that is, the X direction. For example, the waterjet tank 240b may be configured to move based on the movement of the waterjet cutting apparatus 230b in the direction parallel to the first direction, that is, the X direction, to overlap the waterjet cutting apparatus 230b in the third direction, that is, the Z direction. Accordingly, the waterjet tank 240b may be continuously arranged under the waterjet cutting apparatus 230b, and may store the cutting liquid sprayed by the waterjet cutting apparatus 230b.

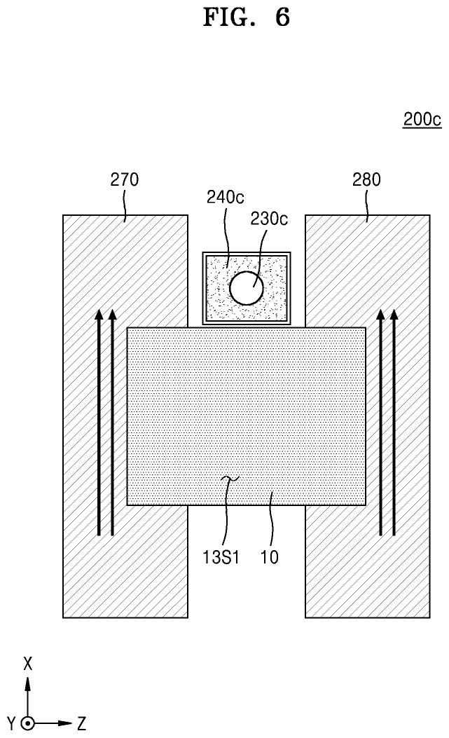

Referring to FIG. 6, the third apparatus 200c for cutting a glass laminated substrate may include a fourth cutting conveyor belt 270, a fifth cutting conveyor belt 280, a waterjet cutting apparatus 230c, and a waterjet tank 240c.

In an embodiment, the fourth cutting conveyor belt 270 and the fifth cutting conveyor belt 280 may be configured to transfer the glass laminated substrate 10 in the first direction, that is, the X direction, which is the process progress direction.

In an embodiment, the fourth cutting conveyor belt 270 and the fifth cutting conveyor belt 280 of the third apparatus 200c for cutting a glass laminated substrate may be spaced apart from each other in the third direction, that is, the Z direction, that is perpendicular to the first direction, that is, the X direction, which is the process progress direction.

Furthermore, an edge portion of the glass laminated substrate 10 may be supported by the fourth cutting conveyor belt 270 and the fifth cutting conveyor belt 280, and a middle portion of the glass laminated substrate 10 may be arranged in a separation space between the fourth cutting conveyor belt 270 and the fifth cutting conveyor belt 280. The separation space between the fourth cutting conveyor belt 270 and the fifth cutting conveyor belt 280 may be a cutting space in which the cutting of the glass laminated substrate 10 is performed by the waterjet cutting apparatus 230c.

In an embodiment, while the glass laminated substrate 10 is transferred by the fourth cutting conveyor belt 270 and the fifth cutting conveyor belt 280 in the first direction, that is, the X direction, the waterjet cutting apparatus 230c may spray the cutting liquid onto the first surface 13S1 of the glass laminated substrate 10 in the second direction, that is, the Y direction.

In an embodiment, the waterjet tank 240c may be arranged under the waterjet cutting apparatus 230c, and may store the cutting liquid sprayed by the waterjet cutting apparatus 230c.

In an embodiment, when the waterjet cutting apparatus 230c sprays the cutting liquid without moving in the third direction, that is, the Z direction, the cutting surface of the glass laminated substrate 10 that is cut by the waterjet cutting apparatus 230c may be a flat surface. Furthermore, when the waterjet cutting apparatus 230c sprays the cutting liquid while moving in the third direction, that is, the Z direction, the cutting surface of the glass laminated substrate 10 that is cut by the waterjet cutting apparatus 230c may be a curved surface.

Referring to FIG. 3 and FIGS. 7 to 9 together, the surface processing apparatus 300 for processing a surface of the glass laminated substrate 10 may be configured to process one surface of the glass laminated substrate 10. In an embodiment, the surface processing apparatus 300 for processing a surface of the glass laminated substrate 10 may be configured to grind, clean, and dry the cutting surface of the glass laminated substrate 10.

In an embodiment, the surface processing apparatus 300 for processing a surface of the glass laminated substrate 10 may include a surface processing conveyor belt 310, an edging apparatus 330, a cleaning apparatus 350, and the drying apparatus 370.

In an embodiment, the surface processing conveyor belt 310 may be configured to receive the glass laminated substrate 10 that is cut by the cutting apparatus 200 through the second cutting conveyor belt 220, and transfer the glass laminated substrate 10 in the first direction, that is, the X direction, to perform the process of processing the surface of the glass laminated substrate 10.

In an embodiment, the surface processing conveyor belt 310 may transfer the glass laminated substrate 10 in the first direction, that is, the X direction, to perform the grinding process, the cleaning process, the drying process, and the like of the glass laminated substrate 10.

In an embodiment, the surface processing conveyor belt 310 may be spaced apart from the second cutting conveyor belt 220 of the cutting apparatus 200 for cutting a glass laminated substrate in the first direction, that is, the X direction, and may transfer the glass laminated substrate 10 received from the second cutting conveyor belt 220 in the first direction, that is, the X direction.

In an embodiment, the surface processing conveyor belt 310 may include a plurality of surface processing rollers 313 and a surface processing transfer belt 315 encompassing the surface processing rollers 313.

In an embodiment, as a plurality of the surface processing rollers 313 rotates clockwise, the surface processing transfer belt 315 encompassing the surface processing rollers 313 may also rotate clockwise. Accordingly, the glass laminated substrate 10 placed on the surface processing transfer belt 315 may be transferred in the first direction, that is, the X direction, which is the process progress direction.

Referring to FIGS. 3 and 7, the edging apparatus 330 of the surface processing apparatus 300 for processing a surface of the glass laminated substrate 10 may be arranged on the surface processing conveyor belt 310 and configured to grind the cutting surface of the glass laminated substrate 10 that is cut by the cutting apparatus 200. For example, the edging apparatus 330 may be configured to chamber the cutting surface of the glass laminated substrate 10 that is cut.

In an embodiment, a part of the glass layer 13 and the substrate 11 of the glass laminated substrate 10 may be ground through the rotation of the edging apparatus 330. For example, while the glass laminated substrate 10 is transferred in the first direction, that is, the X direction, the edging apparatus 330 may grind a part of the glass layer 13 and the substrate 11 of the glass laminated substrate 10 by rotating around an axis extending in the third direction, that is, the Z direction.

In an embodiment, the edging apparatus 330 may include a glass grinding portion 333, a substrate grinding portion 335, and a base portion 337.

In an embodiment, the glass grinding portion 333 may be a portion of the edging apparatus 330 configured to grind a part of the glass layer 13 of the glass laminated substrate 10 through rotation. Furthermore, the glass grinding portion 333 may be arranged above the base portion 337, and may have a tapered shape such that a cross-sectional area thereof increases upward in a horizontal direction, for example, on an X-Y plane.

Furthermore, the substrate grinding portion 335 may be a portion of the edging apparatus 330 configured to grind a part of the substrate 11 of the glass laminated substrate 10 through rotation. Furthermore, the substrate grinding portion 335 may be arranged under the base portion 337, and may have a tapered shape such that a cross-sectional area thereof increases downward in the horizontal direction, for example, on the X-Y plane.

In an embodiment, when the cutting surface of the glass laminated substrate 10 is ground, the glass laminated substrate 10 may be arranged between the glass grinding portion 333 and the substrate grinding portion 335.

In an embodiment, as illustrated in FIG. 7, the edging apparatus 330 may simultaneously grind the glass layer 13 and the substrate 11 of the glass laminated substrate 10 through the rotation. However, the disclosure is not limited thereto, and the edging apparatus 330 may grind the substrate 11 after grinding the glass layer 13 of the glass laminated substrate 10. Furthermore, the edging apparatus 330 may grind the substrate 11 of the glass laminated substrate 10 and then the glass layer 13.

Referring to FIGS. 3 and 8 together, the cleaning apparatus 350 of the surface processing apparatus 300 for processing a surface of the glass laminated substrate 10 may be arranged above the surface processing conveyor belt 310, and configured to clean the surface of the glass laminated substrate 10 ground by the edging apparatus 330.

In an embodiment, the cleaning apparatus 350 may be arranged above the surface processing conveyor belt 310, and may include a cleaning liquid spray apparatus 350a configured to spray a cleaning liquid at high pressure onto the first surface 13S1 of the glass laminated substrate 10. The cleaning liquid that the cleaning liquid spray apparatus 350a sprays onto the glass laminated substrate 10 may be water. However, the type of cleaning liquid is not limited to the above description.

In an embodiment, the cleaning liquid spray apparatus 350a may include a spray nozzle 351 configured to spray the cleaning liquid, a pipe 353 connected to the spray nozzle 351, a cleaning liquid tank (not shown) storing the cleaning liquid, a pump (not shown) configured to apply a pressure to the cleaning liquid, and the like.

In an embodiment, the cleaning liquid spray apparatus 350a may spray the cleaning liquid onto the first surface 13S1 of the glass laminated substrate 10 in the second direction, that is, the Y direction, perpendicular to the first direction, that is, the X direction, which is a transfer direction of the glass laminated substrate 10. However, the disclosure is not limited thereto, and the cleaning liquid spray apparatus 350a may spray the cleaning liquid onto the first surface 13S1 of the glass laminated substrate 10 in a state of being inclined with respect to an axis in the direction parallel to the second direction, that is, the Y direction.

However, the disclosure is not limited thereto, and the cleaning apparatus 350 may include a cleaning brush (not shown) arranged on the surface processing conveyor belt 310 and physically brushing the surface of the glass laminated substrate 10. In an embodiment, the cleaning brush may physically brush the surface of the glass laminated substrate 10 through the rotation.

Referring to FIGS. 3 and 9 together, the drying apparatus 370 of the surface processing apparatus 300 for processing a surface of the glass laminated substrate 10 may be arranged above the surface processing conveyor belt 310 and drying the glass laminated substrate 10 cleaned by the cleaning apparatus 350.

In an embodiment, the drying apparatus 370 of the surface processing apparatus 300 for processing a surface of the glass laminated substrate 10 may include at least one of air knife or air curtain arranged above the surface processing conveyor belt 310 and configured to spray air onto the surface of the glass laminated substrate 10.

In an embodiment, the drying apparatus 370 may include a spray nozzle 371 configured to spray air, a pipe 373 connected to the spray nozzle 371, a compressor configured to apply a pressure to the inner space of the spray nozzle 371, and the like.

The apparatus 100 for manufacturing the glass laminated substrate 10 according to an embodiment may include the cutting apparatus 200 of the glass laminated substrate 10 and the surface processing apparatus 300 of the glass laminated substrate 10 that may simultaneously operate in the process space of within the chamber 110. In other words, the apparatus 100 for manufacturing the glass laminated substrate 10 according to an embodiment may include the cutting apparatus 200 and the surface processing apparatus 300 that may manufacture the glass laminated substrate 10 in-line.

Accordingly, the apparatus 100 for manufacturing the glass laminated substrate 10 according to an embodiment may quickly manufacture a large amount of the glass laminated substrate 10.

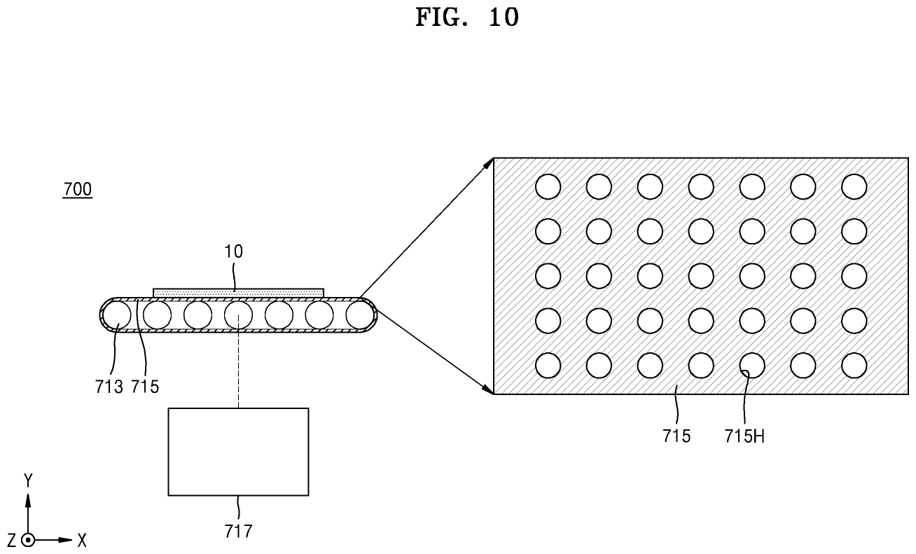

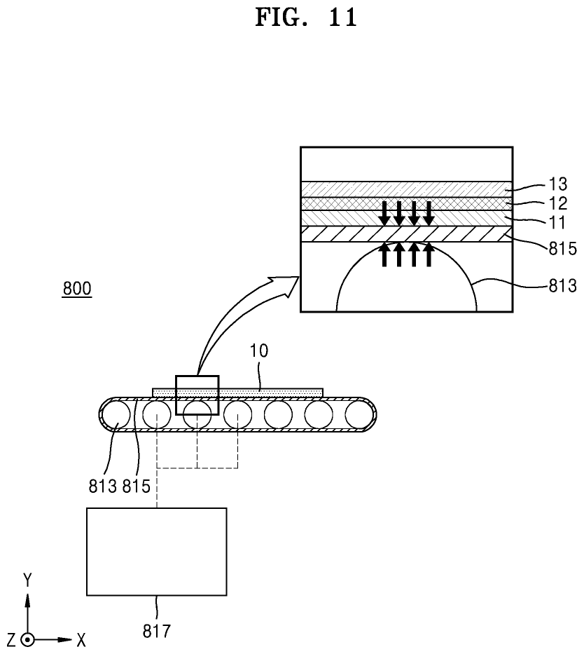

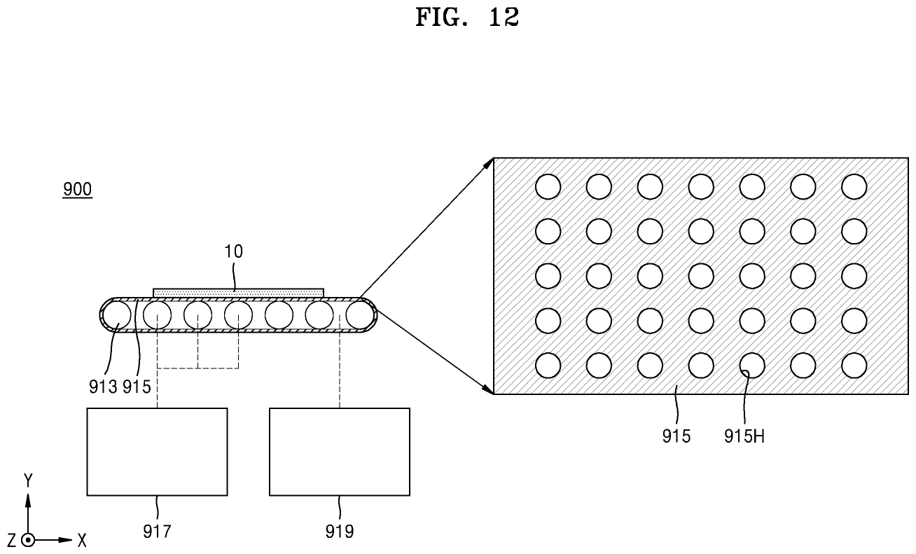

FIGS. 10 and 12 are cross-sectional views of conveyor belts 700, 800, and 900 according to an embodiment.

The technical concepts of the conveyor belts 700, 800, and 900 that are described with reference to FIGS. 10 and 12 may be applied to at least one of the first cutting conveyor belt 210, the second cutting conveyor belt 220, and the surface processing conveyor belt 310 of the apparatus 100 for manufacturing the glass laminated substrate 10 according to an embodiment.

Referring to FIG. 10, the first conveyor belt 700 may include a plurality of first rollers 713 spaced apart from each other in the first direction, that is, the X direction, which is the process progress direction, a first transfer belt 715 encompassing the first rollers 713 and having a plurality of vacuum holes 715H in a surface thereof, and a first vacuum pump 717 configured to provide a lower pressure to the vacuum holes 715H of the first transfer belt 715.

In an embodiment, the first vacuum pump 717 may be connected to an inner space formed by the first transfer belt 715, and may discharge a gas in the inner space to the outside, thereby providing a low pressure to the vacuum holes 715H of the first transfer belt 715.

Accordingly, the glass laminated substrate 10 placed on the first transfer belt 715 may be firmly placed on a surface of the first transfer belt 715 by the low pressure provided by the first vacuum pump 717. In other words, as the vacuum holes 715H of the first transfer belt 715 provides a low pressure to the lower surface of the substrate 11 of the glass laminated substrate 10, the glass laminated substrate 10 may be firmly placed on the surface of the first transfer belt 715.

For example, the first cutting conveyor belt 210 of FIG. 3 may include the first cutting rollers 213 of FIG. 3, the first cutting transfer belt 215 of FIG. 3 encompassing the first cutting rollers 213 and having a plurality of vacuum holes in the surface thereof, and the first vacuum pump 717 configured to provide a lower pressure to the vacuum holes of the first cutting transfer belt 215.

Furthermore, for example, the second cutting conveyor belt 220 of FIG. 3 may include a plurality of second cutting rollers 223 of FIG. 3, a second cutting transfer belt 225 of FIG. 3 encompassing the second cutting rollers 223 and having a plurality of vacuum holes in the surface thereof, and the first vacuum pump 717 configured to provide a low pressure to the vacuum holes of the second cutting transfer belt 225.

Furthermore, for example, the surface processing conveyor belt 310 may include a plurality of surface processing rollers 313 of FIG. 3, a surface processing transfer belt 315 of FIG. 3 encompassing the surface processing rollers 313 and having a plurality of vacuum holes in the surface thereof, and the first vacuum pump 717 configured to provide a low pressure to the vacuum holes of the surface processing transfer belt 315.

Referring to FIG. 11, a second conveyor belt 800 may include a plurality of second rollers 813 arranged spaced apart from each other in the first direction, that is, the X direction, which is the process progress direction, and including a paramagnetic material that is magnetized in a direction parallel to a direction of an external magnetic field, a second transfer belt 815 encompassing the second rollers 813, and a first magnetic field generation apparatus 817 configured to generate a magnetic field to magnetize the second rollers 813.

In an embodiment, the second rollers 813 may include a paramagnetic material that is magnetized in a direction parallel to the direction of the external magnetic field. In other words, when a magnetic field is provided around the second rollers 813, the second rollers 813 may be magnetized to function as a magnet. Furthermore, when the magnetic field around the second rollers 813 is removed, the magnetism of the second rollers 813 may be removed.

In an embodiment, the second rollers 813 may include at least one material of iron (Fe), nickel (Ni), or platinum (Pt). In detail, the second rollers 813 may include at least one material of iron (Fe) or stainless steel.

In an embodiment, the first magnetic field generation apparatus 817 may be configured to generate a magnetic field around the second rollers 813 to magnetize the second rollers 813.

In an embodiment, the first magnetic field generation apparatus 817 may include a wiring (not shown) of a conductive material, a current application apparatus (not shown) configured to apply a current to the wiring, and the like. For example, the wiring may have a spring shape, and when a current is applied to the wiring, a magnetic field may be formed inside and outside the wiring.

In an embodiment, when the first magnetic field generation apparatus 817 is operated, that is, the current application apparatus applies a current to the wiring, a magnetic field may be generated around the second rollers 813. Accordingly, the second rollers 813 may be magnetized in a direction parallel to a direction of a magnetic field generated by the first magnetic field generation apparatus 817.

Furthermore, when the substrate 11 of the glass laminated substrate 10 includes a paramagnetic material, for example, iron (Fe), due to the magnetic field generated by the first magnetic field generation apparatus 817, the substrate 11 of the glass laminated substrate 10 may also be magnetized in the direction parallel to the direction of the magnetic field.

Accordingly, electrostatic attraction may be generated between the second rollers 813 and the substrate 11 of the glass laminated substrate 10, and thus the glass laminated substrate 10 may be firmly placed on a surface of the second transfer belt 815.

Furthermore, in an embodiment, the second transfer belt 815 may include a rubber magnet. When the substrate 11 of the glass laminated substrate 10 includes a paramagnetic material, for example, iron (Fe), due to the electrostatic attraction acting between the second transfer belt 815 and the substrate 11, the glass laminated substrate 10 may be firmly placed on the surface of the second transfer belt 815.

The technical concept of the second conveyor belt 800 described with reference to FIG. 11 may be applied to the first cutting conveyor belt 210, the second cutting conveyor belt 220, and the surface processing conveyor belt 310 that are described with reference to FIGS. 3 to 9.

Referring to FIG. 12, a third conveyor belt 900 may include a plurality of third rollers 913 arranged spaced apart from each other in the first direction, that is, the X direction, which is the process progress direction and including a paramagnetic material magnetized in the direction parallel to the direction of an external magnetic field, a third transfer belt 915 encompassing the third rollers 913 and including a plurality of vacuum holes 915H in the surface thereof, a third vacuum pump 917 configured to provide a low pressure to the vacuum holes 915H of the third transfer belt 915, and a third magnetic field generation apparatus 919 configured to generate a magnetic field to magnetize the third rollers 913.

As the technical concept of constituent elements of the third conveyor belt 900 is identical to that of the first and second conveyor belts 700 and 800 described with reference to FIGS. 10 and 11, redundant descriptions thereof are omitted.

In an embodiment, when the substrate 11 of the glass laminated substrate 10 includes a paramagnetic material, for example, iron (Fe), the third rollers 913 may be magnetized by the magnetic field generated by the third magnetic field generation apparatus 919. Accordingly, electrostatic attraction may be generated between the third rollers 913 and the substrate 11 of the glass laminated substrate 10, and thus the glass laminated substrate 10 may be firmly placed on a surface of the third transfer belt 915.

In an embodiment, when the substrate 11 of the glass laminated substrate 10 includes a non-magnetic material, for example, wood, the third vacuum pump 917 may discharge a gas in the inner space formed by the third transfer belt 915 to the outside, thereby providing a low pressure to the vacuum holes 915H of the third transfer belt 915.

Accordingly, the glass laminated substrate 10 placed on the third transfer belt 915 may be firmly placed on the surface of the third transfer belt 915 by the low pressure provided by the third vacuum pump 917.

The technical concept of the third conveyor belt 900 described with reference to FIG. 12 may be applied to the first cutting conveyor belt 210, the second cutting conveyor belt 220, and the surface processing conveyor belt 310 that are described with reference to FIGS. 3 to 9.

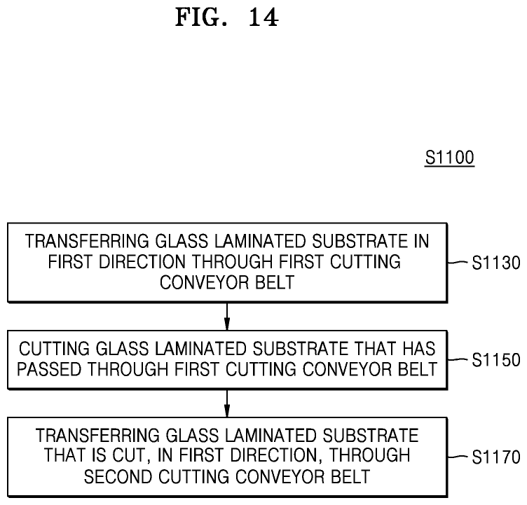

FIG. 13 is a flowchart of a method (S100) of manufacturing the glass laminated substrate 10 according to an embodiment. Furthermore, FIG. 14 is a flowchart of an operation of cutting the glass laminated substrate 10 according to an embodiment.

Referring to FIG. 13, the method (S100) of manufacturing the glass laminated substrate 10 according to an embodiment may include the operations of cutting the glass laminated substrate 10 (S1100), grinding the glass laminated substrate 10 (S1200), cleaning the glass laminated substrate 10 (S1300), drying the glass laminated substrate 10 (S1400), and the like.

In an embodiment, the cutting operation (S1100), the grinding operation (S1200), the cleaning operation (S1300), and the drying operation (S1400) of the glass laminated substrate 10 of the method (S100) of manufacturing the glass laminated substrate 10 may be simultaneously performed within the chamber 110 of FIG. 3 that is one.

For example, any one of the glass laminated substrates 10 that are manufactured within the chamber 110 through the method (S100) of manufacturing the glass laminated substrate 10 according to an embodiment of the disclosure may be a substrate on which the cutting operation (S1100) is performed, and another substrate may be a substrate on which, after the cutting operation (S1100), any one of the grinding operation (S1200), the cleaning operation (S1300), and the drying operation (S1400) of the glass laminated substrate 10 is performed.

The operation S1100 may be the cutting of the glass laminated substrate 10 through the cutting apparatus 200 of the glass laminated substrate 10 according to an embodiment that is described with reference to FIG. 3.

Referring to FIGS. 13 and 14 together, the operation S1100 may include transferring the glass laminated substrate 10 in the first direction, that is, the X direction, through the first cutting conveyor belt 210 of FIG. 3 (S1130), cutting the glass laminated substrate 10 that has passed through the first cutting conveyor belt 210, through the waterjet cutting apparatus 230 of FIG. 3 (S1150), and transferring the glass laminated substrate 10 that is cut, in the first direction, that is, the X direction, through the second cutting conveyor belt 220 of FIG. 3 (S1170).

In an embodiment, the operation S1130 may include fixing the glass laminated substrate 10 on the first cutting conveyor belt 210 of FIG. 3 through a vacuum and fixing the glass laminated substrate 10 on the first cutting conveyor belt 210 through electrostatic attraction.

In an embodiment, the operation S1150 may include an operation in which the waterjet cutting apparatus 230 sprays the cutting liquid onto the glass laminated substrate 10 arranged in the separation space between the first cutting conveyor belt 210 and the second cutting conveyor belt 220.

Furthermore, the operation S1150 may include an operation of controlling the movement of the waterjet tank 240 that stores the cutting liquid based on the movement of the waterjet cutting apparatus 230.

In an embodiment, in the operation S1150, as the waterjet cutting apparatus 230 moves in the direction parallel to the first direction, that is, the X direction, the waterjet tank 240 may move in the direction parallel to the first direction, that is, the X direction, on a bottom surface of the chamber 110, based on the movement of the waterjet cutting apparatus 230.

In an embodiment, the operation S1170 may include fixing the glass laminated substrate 10 on the second cutting conveyor belt 220 of FIG. 3 through a vacuum and fixing the glass laminated substrate 10 on the second cutting conveyor belt 220 through electrostatic attraction.

As the technical concept of the fixing of the glass laminated substrate 10 on a conveyor belt through the vacuum and/or electrostatic attraction performed in the operation S1130 and the operation S1170 is identical to that described with reference to FIGS. 10 and 12, a detailed description thereof is omitted.

The operation S1200 may include grinding a part of the glass laminated substrate 10 through the edging apparatus 330 that rotates around an axis extending in the second direction, that is, the Y direction, that is perpendicular to the first direction, that is, the X direction, while the glass laminated substrate 10 moves in the first direction, that is, the X direction, through the surface processing conveyor belt 310.

In an embodiment, in the operation S1200, the glass grinding portion 333 of the edging apparatus 330 may grind the glass layer 13 of the glass laminated substrate 10 through the rotation. Furthermore, the substrate grinding portion 335 of the edging apparatus 330 may grind the substrate 11 of the glass laminated substrate 10 through the rotation.

The operation S1300 may include spraying the cleaning liquid onto the surface of the glass laminated substrate 10 through the cleaning liquid spray apparatus 350a of FIG. 8, while the glass laminated substrate 10 moves in the first direction, that is, the X direction, through the surface processing conveyor belt 310.

The operation S1400 may include spraying air onto the surface of the glass laminated substrate 10 through the drying apparatus 370, while the glass laminated substrate 10 moves in the first direction, that is, the X direction, through the surface processing conveyor belt 310.

In the method (S100) of manufacturing the glass laminated substrate 10 according to an embodiment, the cutting operation (S1100), the grinding operation (S1200), the cleaning operation (S1300), and the drying operation (S1400) of the glass laminated substrate 10 may be simultaneously performed within the chamber 110 that is one.

Accordingly, in the method (S100) of manufacturing the glass laminated substrate 10 according to an embodiment, a large amount of the glass laminated substrate 10 may be quickly manufactured.

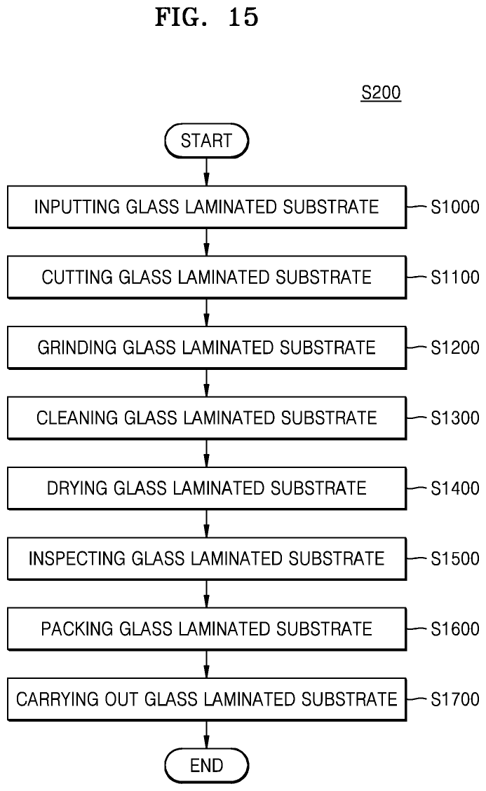

FIG. 15 is a flowchart of a method (S200) of manufacturing the glass laminated substrate 10 according to an embodiment.

The method (S200) of manufacturing the glass laminated substrate 10 according to an embodiment may include inputting the glass laminated substrate 10 (S1000), the cutting operation (S1100), the grinding operation (S1200), the cleaning operation (S1300), the drying operation (S1400), inspecting the glass laminated substrate 10 (S1500), packing the glass laminated substrate 10 (S1600), carrying out the glass laminated substrate 10 (S1700), and the like.

In the following description, any redundant descriptions with the method (S100) of manufacturing the glass laminated substrate 10 presented with reference to FIG. 14 are omitted, and differences therebetween are mainly described below.

In an embodiment, the operation S1000 may include inputting the glass laminated substrate 10 onto the first cutting conveyor belt 210 by using at least one of a magazine or a cassette.

In an embodiment, the operation S1500 may include inspecting whether the cutting process and the surface processing process of the glass laminated substrate 10 are normally performed, while the glass laminated substrate 10 moves in the first direction, that is, the X direction, through the surface processing conveyor belt 310.

In an embodiment, in the operation S1500, whether the glass laminated substrate 10 has cracks may be inspected by using illumination and camera, and the like. Furthermore, by inspecting whether the glass laminated substrate 10 has cracks, the glass laminated substrate 10 may be determined to be a quality product or a defective product. Furthermore, in the operation S1500, the drying state of the glass laminated substrate 10, cracks of the glass laminated substrate 10, and the like may be inspected.

In an embodiment, the operation S1600 may include stacking the glass laminated substrates 10. Furthermore, the operation S1600 may include packaging the glass laminated substrates 10. For example, the operation S1600 may include putting the glass laminated substrates 10 that is stacked, into a packaging container after stacking the glass laminated substrates 10.

In an embodiment, in the operation S1700, the glass laminated substrate 10 may be carried out from the surface processing conveyor belt 310, and the glass laminated substrate 10 may be input into at least one of a magazine or a cassette.

In the method (S200) of manufacturing the glass laminated substrate 10 according to an embodiment, the inputting operation (S1000), the cutting operation (S1100), the grinding operation (S1200), the cleaning operation (S1300), the drying operation (S1400), the inspection operation (S1500), the packing operation (S1600), and the carrying-out operation (S1700) of the glass laminated substrate 10 may be simultaneously performed within the chamber 110 that is one.

Accordingly, according to the method (S200) of manufacturing the glass laminated substrate 10 according to an embodiment, a large amount of the glass laminated substrate 10 may be quickly manufactured.

Although the configuration and effect of the inventive concept are described above in detail with specific embodiments and comparative examples, the embodiments of the inventive concept are provided to have the inventive concept to be clearly understood, not to limit the scope of the inventive concept.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An apparatus for manufacturing a glass laminated substrate, the apparatus comprising:
a chamber;
a cutting apparatus for cutting the glass laminated substrate, the cutting apparatus being arranged in the chamber and comprising: a first cutting conveyor belt configured to transfer the glass laminated substrate in a first direction; a second cutting conveyor belt arranged apart from the first cutting conveyor belt in the first direction and configured to transfer the glass laminated substrate in the first direction; and a waterjet cutting apparatus configured to cut the glass laminated substrate by spraying a cutting liquid toward the glass laminated substrate located in a spacing between the first cutting conveyor belt and the second cutting conveyor belt; and
a surface processing apparatus arranged beside the cutting apparatus in the chamber for processing a surface of the glass laminated substrate, the surface processing apparatus comprising: a surface processing conveyor belt arranged apart from the second cutting conveyor belt in the first direction and configured to transfer the glass laminated substrate in the first direction; a beveling apparatus arranged above the surface processing conveyor belt and configured to chamfer a part of the glass laminated substrate that is cut; a cleaning apparatus arranged above the surface processing belt and configured to clean a surface of the glass laminated substrate; and a drying apparatus arranged above the surface processing conveyor belt and configured to dry the surface of the glass laminated substrate.

2. The apparatus of claim 1, wherein the cutting apparatus of the glass laminated substrate further comprises a waterjet tank arranged between the first cutting conveyor belt and the second cutting conveyor belt and configured to store the cutting liquid discharged from the waterjet cutting apparatus.

3. The apparatus of claim 2, wherein the cutting apparatus of the glass laminated substrate further comprises a third cutting conveyor belt arranged apart from the second cutting conveyor belt in the first direction and configured to transfer the glass laminated substrate in the first direction, and
the waterjet cutting apparatus is further configured to move in a direction parallel to the first direction and to spray the cutting liquid toward at least one of the glass laminated substrate arranged between the first cutting conveyor belt and the second cutting conveyor belt or the glass laminated substrate arranged between the second cutting conveyor belt and the third cutting conveyor belt.

4. The apparatus of claim 3, wherein the waterjet tank is further configured to move in a direction parallel to the first direction in the chamber based on a movement of the waterjet cutting apparatus in the direction parallel to the first direction.

5. The apparatus of claim 1, wherein the beveling apparatus comprises:
a base portion;
a glass beveling portion arranged above the base portion and configured to grind a glass layer of the glass laminated substrate through rotation; and
a substrate beveling portion arranged below the base portion and configured to grind a substrate under the glass layer of the glass laminated substrate through rotation.

6. The apparatus of claim 1, wherein the cleaning apparatus comprises
a cleaning liquid sprayer configured to spray a cleaning liquid onto the surface of the glass laminated substrate.

7. The apparatus of claim 1, wherein the drying apparatus comprises at least one of an air knife or an air curtain, which is configured to spray air onto the surface of the glass laminated substrate.

8. The apparatus of claim 1, wherein at least one of the first cutting conveyor belt, the second cutting conveyor belt, or the surface processing conveyor belt comprises:
a plurality of rollers arranged apart from one another in the first direction;
a transfer belt surrounding the plurality of rollers and having a plurality of vacuum holes in a surface thereof; and
a vacuum pump configured to supply a low pressure to the plurality of vacuum holes of the transfer belt.

9. The apparatus of claim 1, wherein at least one of the first cutting conveyor belt, the second cutting conveyor belt, or the surface processing conveyor belt comprises:
a plurality of rollers arranged apart from one another in the first direction; and
a transfer belt surrounding the plurality of rollers and comprising a rubber magnet.

10. The apparatus of claim 1, wherein at least one of the first cutting conveyor belt, the second cutting conveyor belt, or the surface processing conveyor belt comprises:
a plurality of rollers arranged apart from one another in the first direction and each comprising a paramagnetic material that is magnetized in a direction parallel to a direction of a magnetic field;
a transfer belt surrounding the plurality of rollers; and
a magnetic field generation apparatus configured to generate a magnetic field to magnetize the plurality of rollers.

11. The apparatus of claim 8, wherein at least one of the first cutting conveyor belt, the second cutting conveyor belt, or the surface processing conveyor belt further comprises a magnetic field generation apparatus configured to generate a magnetic field to magnetize the plurality of rollers, and
the plurality of rollers each comprise a paramagnetic material that is magnetized in a direction parallel to a direction of the magnetic field.

12. A method of manufacturing a glass laminated substrate, the method comprising:
cutting the glass laminated substrate;
chamfering a part of the glass laminated substrate;
cleaning the glass laminated substrate; and
drying the glass laminated substrate,
wherein the cutting, chamfering, cleaning, and drying of the glass laminated substrate are performed within a single chamber.

13. The method of claim 12, wherein the cutting of the glass laminated substrate comprises:
transferring the glass laminated substrate in a first direction via a first cutting conveyor belt;
cutting, by using a waterjet cutting apparatus, a part of the glass laminated substrate that passed the first cutting conveyor belt; and
transferring, via a second cutting conveyor belt that is apart from the first cutting conveyor belt in the first direction, the glass laminated substrate that is cut.

14. The method of claim 13, wherein the cutting, by using the waterjet cutting apparatus, of a part of the glass laminated substrate that passed the first cutting conveyor belt comprises controlling a movement of a waterjet tank that stores a cutting liquid sprayed by the waterjet cutting apparatus, based on a movement of the waterjet cutting apparatus in a direction parallel to the first direction.

15. The method of claim 13, wherein the transferring of the glass laminated substrate in the first direction via the first cutting conveyor belt comprises any one of fixing the glass laminated substrate on the first cutting conveyor belt through a vacuum and fixing the glass laminated substrate on the first cutting conveyor belt through electrostatic attraction, and
the transferring of the glass laminated substrate in the first direction via the second cutting conveyor belt comprises any one of fixing the glass laminated substrate on the second cutting conveyor belt through a vacuum and fixing the glass laminated substrate on the second cutting conveyor belt through electrostatic attraction.

16. The method of claim 12, wherein the chamfering of a part of the glass laminated substrate comprises grinding a glass layer of the glass laminated substrate and a substrate disposed under the glass layer through rotation of a beveling apparatus while the glass laminated substrate is moving in the first direction.

17. The method of claim 12, wherein the cleaning of the glass laminated substrate comprises spraying a cleaning liquid onto a surface of the glass laminated substrate while the glass laminated substrate is moving in the first direction.

18. The method of claim 12, wherein the drying of the glass laminated substrate comprises spraying air onto a surface of the glass laminated substrate while the glass laminated substrate is moving in the first direction.

19. The method of claim 12, further comprising:
inspecting a surface of the glass laminated substrate; and
packing the glass laminated substrate,
wherein the cutting, chamfering, cleaning, drying, inspecting, and packing of the glass laminated substrate are performed within a single chamber.
